(19) United States
(12) Patent Application Publication
(10) Pub. No.: US 2026/0192239 A1
(43) Pub. Date: Jul. 9, 2026

(54) ADSORPTION-DESORPTION CONCENTRATION DEVICE CAPABLE OF REGULATING DESORPTION AIR VOLUME OR CONCENTRATION RATIO AND CONCENTRATION METHOD THEREOF

(71) Applicant: JG ENVIRONMENTAL TECHNOLOGY CO., LTD, Taoyuan City (TW)

(72) Inventors: FENG-TANG CHANG, Taoyuan City (TW); CHIEN-LIANG HWANG, Taoyuan City (TW); SHAO-CHIEN CHANG, Taoyuan City (TW)

(73) Assignee: JG ENVIRONMENTAL TECHNOLOGY CO., LTD, Taoyuan City (TW)

(21) Appl. No.: 19/373,763

(22) Filed: Oct. 30, 2025

(30) Foreign Application Priority Data
Jan. 9, 2025 (TW) 114100897

(51) Int. Cl. B01D 53/06

(52) U.S. Cl. CPC B01D 53/06; B01D 2257/708; B01D 2258/02; B01D 2259/40086

(57) ABSTRACT

The present disclosure introduces an adsorption-desorption concentration device capable of regulating desorption air volume or concentration ratio and a concentration method thereof, which consists of providing organic waste gas to be purified and output through an adsorption and desorption material, and providing desorption gas to output concentrated gas from a desorption gas outlet pipe through the adsorption and desorption material. When the source air volume and/or concentration of the organic waste gas is low, a control unit controls a concentrated gas bypass pipe to be communicated, so that the concentrated gas with relatively high concentration in the desorption gas outlet pipe is added to a waste gas inlet pipe to compensate the air volume, achieving better purification efficiency and increasing the concentration of the organic waste gas to help save fuel and reduce nitrogen oxide emissions without increasing the air volume of the concentrated gas outlet pipe.

### CROSS-REFERENCE TO RELATED APPLICATION

This non-provisional application claims priority under 35 U.S.C. § 119(a) on Patent Application No(s). 114100897 filed in Taiwan, R.O.C. on Jan. 9, 2025, the entire contents of which are hereby incorporated by reference.

### BACKGROUND OF THE INVENTION

### 1. Field of the Invention

The present disclosure relates to purification treatment of organic waste gas, and in particular, to an adsorption-desorption concentration device capable of regulating desorption air volume or concentration ratio and a concentration method thereof.

### 2. Description of the Related Art

Volatile organic compounds (VOCs) produced in industrial processes, for example, waste gas produced due to the use of organic solvents in semiconductor processes, have to be subjected to purification treatment. For example, organic waste gas is concentrated through the process of adsorption and desorption carried out in a concentrator, and then the concentrated organic waste gas is fed into an incinerator for combustion and purification into water and carbon dioxide before being discharged, thereby avoiding environmental pollution.

Taking the concentration process of the organic waste gas, for example, the concentration process in which organic substances are adsorbed and desorbed by a wheel as an example, when the wheel runs, a ratio of a source air volume of the organic waste gas passing through an adsorption zone to a desorption air volume of desorption gas passing through a desorption zone is taken as a concentration ratio of the wheel; and when a treated air volume passing through the adsorption zone is low, the desorption air volume or the concentration ratio may be less than a preset value. To control the concentration ratio at the preset value to maintain the purification efficiency, the desorption air volume of the desorption gas passing through the desorption zone needs to be decreased, thereby leading to the difficulty for desorption heat of the desorption gas to fully penetrate through the desorption zone due to insufficient air volume and face velocity, and thus leading to a sharp drop in the outlet temperature when the desorption gas is discharged from the wheel. Therefore, the problem that the concentration of the organic waste gas is reduced due to insufficient desorption arises, and thus the efficiency of adsorption and desorption purification of the wheel is reduced. In addition, taking the concentration process of the organic waste gas in combination with incineration, for example, the concentration process in which the wheel adsorbs and desorbs the organic substances, and then the organic substances enter an incineration unit for incineration as an example, when the wheel runs, a ratio of the source air volume of the organic waste gas passing through the adsorption zone to an air volume of combustion waste gas entering a final treatment incineration unit after the desorption gas passing through the desorption zone is taken as a system concentration ratio.

Furthermore, when the source concentration of the organic waste gas passing through the adsorption zone is low, the concentration of the concentrated gas desorbed by the wheel accordingly decreases. When the organic waste gas enters a thermal oxidizer for combustion, not only does the low concentration of the organic gas requires additional heating value to be increased and thus consume fuel, but also the concentration of thermal NOx produced by combustion is high, thereby leading to the increase of the concentration of NOx emitted by combustion. Thus, the requirements of environmental protection laws and regulations for NOx emission may not be met. Therefore, how to solve the above-mentioned problems in the prior art is the focus of the present disclosure.

### BRIEF SUMMARY OF THE INVENTION

To solve the above-mentioned problems, the inventors provide an adsorption-desorption concentration device capable of maintaining desorption air volume or concentration ratio and a concentration method thereof, which can control the desorption air volume or concentration ratio of organic waste gas in the adsorption-desorption concentration process to be maintained at a preset value, thereby maintaining the purification efficiency and effectively reducing nitrogen oxide emissions.

To achieve the above-mentioned purpose, the present disclosure provides an adsorption-desorption concentration device capable of regulating desorption air volume or concentration ratio. The adsorption-desorption concentration device is used for gas concentration of an organic waste gas purification apparatus, and includes an adsorption and desorption unit, an organic waste gas supply unit, a desorption gas supply unit, and a control unit. The adsorption and desorption unit is provided with an adsorption and desorption material and includes an adsorption zone and a desorption zone. The adsorption zone is connected with a waste gas inlet pipe and a purified gas emission pipe. The desorption zone is connected with a desorption gas inlet pipe and a desorption gas outlet pipe. The desorption gas outlet pipe is communicated with a concentrated gas outlet pipe. The desorption gas outlet pipe and the waste gas inlet pipe are connected by a concentrated gas bypass pipe, and a control valve is arranged to control the concentrated gas bypass pipe to be communicated or not communicated; wherein an organic waste gas is provided via the waste gas inlet pipe to pass through the adsorption and desorption material from the adsorption zone at a source air volume, and a desorption gas is provided via the desorption gas inlet pipe to pass through the adsorption and desorption material from the desorption zone at a desorption air volume. The organic waste gas supply unit is connected to the waste gas inlet pipe to provide organic waste gas to pass through the adsorption and desorption material from the adsorption zone at the source air volume for purification, and then purified gas is discharged from the purified gas emission pipe. The desorption gas supply unit is connected to the desorption gas inlet pipe to provide desorption gas to pass through the adsorption and desorption material from the desorption zone at a desorption air volume for desorption, and then concentrated gas produced is discharged from the desorption gas outlet pipe and the concentrated gas outlet pipe. The control unit is electrically connected with the control valve, the organic waste gas supply unit and the desorption gas supply unit. The control unit receives the source air volume and the desorption air volume, and when the source air volume and/or the concentration of organic waste gas are/is low, the control unit is adjusted to control the control valve to make the concentrated gas bypass pipe to be communicated to allow the concentrated gas flowing at the desorption air volume in the desorption gas outlet pipe to be added to the waste gas inlet pipe to compensate the source air volume at which the organic waste gas flows, so that the desorption air volume or the concentration ratio is controlled at a better wheel purification efficiency.

In an embodiment, the waste gas inlet pipe is provided with a first air volume detector, and the first air volume detector is configured to detect the source air volume. The concentrated gas outlet pipe is provided with a second air volume detector, and the second air volume detector is configured to detect the desorption air volume. The control unit is electrically connected to the first air volume detector and the second air volume detector to receive the source air volume and the desorption air volume, respectively.

In an embodiment, the purified gas emission pipe is connected to an adsorption fan. The adsorption fan is electrically connected with the control unit, and the control unit controls the adsorption fan to be turned on to produce the source air volume.

In an embodiment, the desorption gas outlet pipe and/or the concentrated gas outlet pipe are/is connected to a desorption fan. The desorption fan is electrically connected with the control unit, and the control unit controls the desorption fan to be turned on to produce the desorption air volume. A communication location of the concentrated gas bypass pipe and the waste gas inlet pipe is located behind the desorption fan.

In an embodiment, the concentrated gas bypass pipe is connected to a compensation fan. The compensation fan is electrically connected with the control unit. An inlet end of the concentrated gas bypass pipe is communicated with the desorption gas outlet pipe and located in front of the desorption fan, and an outlet end of the concentrated gas bypass pipe is communicated with the waste gas inlet pipe. While making the control valve open, the control unit also makes the compensation fan to be turned on, and the concentrated gas from the desorption gas outlet pipe is drawn into the concentrated gas bypass pipe from the inlet end by the compensation fan, and is introduced into the waste gas inlet pipe from the outlet end.

In an embodiment, the concentrated gas bypass pipe is connected to a non-destructive organic waste gas treater between the compensation fan and the outlet end.

In an embodiment, the first air volume detector or the second air volume detector is one of a flame ionization detector, a pitot tube, and a flow-restriction plate.

In an embodiment, the adsorption and desorption unit is a wheel capable of rotating the adsorption and desorption material, and an adsorption and desorption sequence when the adsorption and desorption material rotates is that the organic waste gas first passes through the adsorption zone to allow organic substances to be adsorbed on the adsorption and desorption material, and then returns to the adsorption zone after the organic substances being concentrated and desorbed by the desorption gas in the desorption zone, and this cycle continues.

In an embodiment, the adsorption and desorption unit further includes a cooling zone. The cooling zone is provided with a cooling gas inlet pipe and a cooling gas outlet pipe. Cooling gas passes through the adsorption and desorption material from the cooling gas inlet pipe and then is discharged from the cooling gas outlet pipe to cool the adsorption and desorption material that rotates to the cooling zone.

In an embodiment, a heat exchange unit is further included. The heat exchange unit is connected between the cooling gas outlet pipe and the desorption gas inlet pipe. The cooling gas flows into the heat exchange unit for heating after being discharged from the cooling gas outlet pipe, and then enters the desorption gas inlet pipe to form the desorption gas.

In an embodiment, an incineration unit is further included. The incineration unit is arranged in a combustion chamber provided in the heat exchange unit. The organic waste gas enters the combustion chamber from the concentrated gas outlet pipe, and the incineration unit incinerates and purifies the organic substances into high-temperature gas, and the high-temperature gas provides a heat source for the heat exchange unit to carry out heat exchange.

In an embodiment, the incineration unit is a recuperative thermal oxidizer, a regenerative thermal oxidizer, or a catalytic thermal oxidizer.

The present disclosure further provides an adsorption-desorption concentration method, which includes the following steps: adsorption: providing, through the waste gas inlet pipe, the organic waste gas to pass through the adsorption and desorption material from the adsorption zone at the source air volume, and detecting the source air volume for the organic waste gas flowing in the waste gas inlet pipe; desorption: providing, through the desorption gas inlet pipe, the desorption gas to pass through the adsorption and desorption material from the desorption zone at a desorption air volume for desorption to produce the concentrated gas, and detecting the desorption air volume for the desorption gas flowing in the desorption gas inlet pipe; and air volume compensation: during the execution of the steps of the adsorption and the desorption, obtaining, by the control unit, an instant concentration ratio according to a ratio of the source air volume to the desorption air volume, and further determining whether the desorption air volume or the instant concentration ratio is lower than a preset value, if yes, controlling, by the control unit, the control valve to make the concentrated gas bypass pipe to be communicated to allow the concentrated gas flowing at the desorption air volume in the desorption gas outlet pipe to be added to the waste gas inlet pipe to compensate the source air volume at which the organic waste gas flows, until the desorption air volume or the instant concentration ratio meets the preset value, and then controlling, by the control unit, the control valve to make the concentrated gas bypass pipe to be not communicated. The steps are cycled to enable the desorption air volume or the instant concentration ratio to be maintained at the preset value.

Therefore, according to the adsorption-desorption concentration device capable of regulating desorption air volume or concentration ratio and the concentration method thereof provided by the present disclosure, the concentrated gas in the desorption gas outlet pipe is added to the waste gas inlet pipe to compensate the air volume of the organic waste gas, so that the desorption air volume or the instant concentration ratio can be controlled at a preset value, thereby maintaining a better wheel purification efficiency, and the desorption air volume can be regulated and the concentration of organic waste gas in the concentrated gas outlet pipe and the waste gas inlet pipe can be increased to help shorten the combustion time and thus save fuel and reduce nitrogen oxide emissions without increasing the air volume of the concentrated gas outlet pipe, thereby complying with environmental protection laws and regulations.

### BRIEF DESCRIPTION OF THE DRAWINGS

FIG. 1 is a schematic diagram of a system architecture and an implementation state diagram according to a first embodiment of the present disclosure, showing that in scenario A, the concentration of a waste gas source is 100 PPMv, a source air volume is 150000 NCMH, a desorption air volume is 8333 NCMH, and no concentrated gas is added to a waste gas inlet pipe in a bypassed manner; and TIC is a temperature indicating controller.

FIG. 2 is a schematic diagram of a wheel and an adsorption and desorption process according to a first embodiment of the present disclosure.

FIG. 3 is a block diagram of a control unit according to a first embodiment of the present disclosure.

FIG. 4 is a flowchart of an adsorption-desorption concentration method for organic waste gas according to a specific embodiment of the present disclosure.

FIG. 5 is a continuation of the schematic diagram of the system architecture and the implementation state diagram as shown in FIG. 1, showing that in scenario B, the concentration of the waste gas source is reduced to 10 PPMv.

FIG. 6 is a continuation of the schematic diagram of the system architecture and the implementation state diagram as shown in FIG. 5, showing that in scenario C, concentrated gas is added to a waste gas inlet pipe in a bypassed manner via a concentrated gas bypass pipe.

FIG. 7 is a schematic diagram of a system architecture and another implementation state diagram according to a first embodiment of the present disclosure, showing that in scenario D, the concentration of a waste gas source is 100 PPMv, a source air volume is 150000 NCMH, a desorption air volume is 4167 NCMH, and no concentrated gas is added to a waste gas inlet pipe in a bypassed manner.

FIG. 8 is a schematic diagram of a system architecture and still another implementation state diagram according to a first embodiment of the present disclosure, showing that in scenario E, the concentration of a waste gas source is 100 PPMv, a source air volume is 75000 NCMH, a desorption air volume is 8333 NCMH, and no concentrated gas is added to a waste gas inlet pipe in a bypassed manner.

FIG. 9 is a continuation of the schematic diagram of the system architecture and the implementation state diagram as shown in FIG. 8, showing that in scenario F, concentrated gas is added to a waste gas inlet pipe in a bypassed manner via a concentrated gas bypass pipe.

FIG. 10 is a schematic diagram of a system architecture according to a second embodiment of the present disclosure.

FIG. 11 is a schematic diagram of a system architecture according to a third embodiment of the present disclosure.

FIG. 12 is a schematic diagram of a system architecture according to a fourth embodiment of the present disclosure.

FIG. 13 is a schematic diagram of a system architecture according to a fifth embodiment of the present disclosure.

FIG. 14 is a schematic diagram of a system architecture according to a sixth embodiment of the present disclosure.

### DETAILED DESCRIPTION OF THE INVENTION

To fully understand the purposes, features and efficacy of the present disclosure, the present disclosure is described below in detail by means of the following specific embodiments in conjunction with the accompanying drawings.

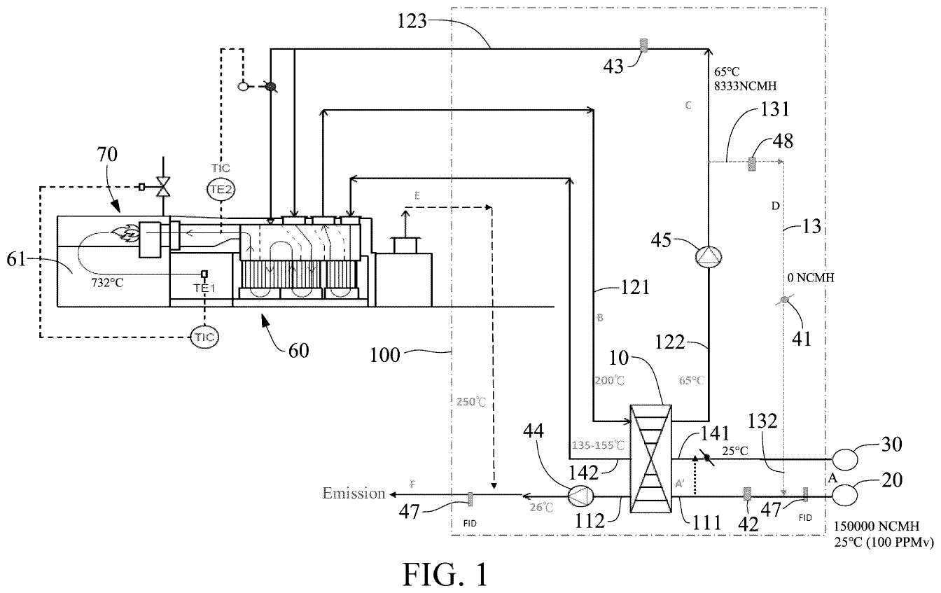

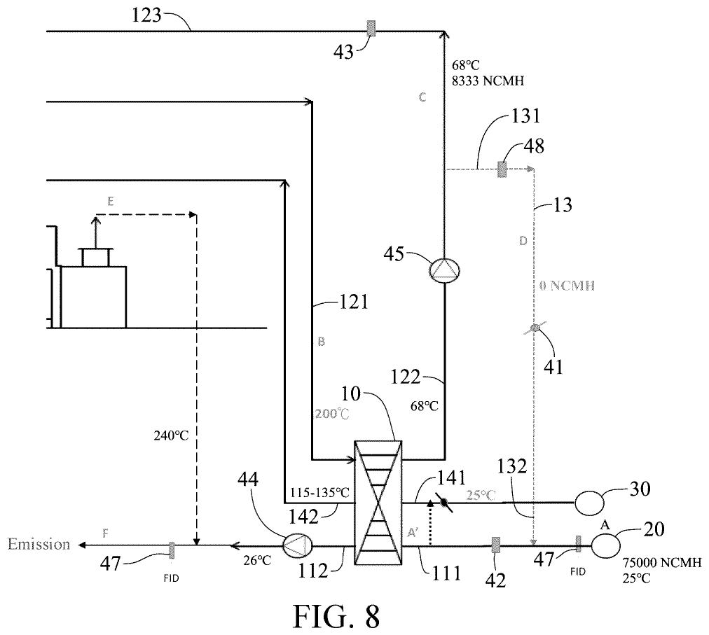

Referring to FIG. 1 to FIG. 14, the present disclosure provides an adsorption-desorption concentration device 100 capable of regulating desorption air volume or concentration ratio and a concentration method 200 thereof, which are used for gas concentration of an organic waste gas purification apparatus. The organic waste gas is mainly volatile organic waste gas, which is gas volatilized from organic solvents. The gas is common in industrial process environments such as electronics industry, surface coating industry, packaging material printing industry, adhesive tape industry, copper foil substrate industry and PU/PVC leather industry and petrochemical industry. Since contained volatile organic compounds (VOCs) are toxic and harmful to human bodies, purification treatment is necessary.

A first embodiment of the adsorption-desorption concentration device 100 capable of regulating desorption air volume or concentration ratio of the present disclosure is shown in FIG. 1 to FIG. 9, which includes an adsorption and desorption unit (which is a wheel 10 in this embodiment), an organic waste gas supply unit 20, a desorption gas supply unit 30, and a control unit 40.

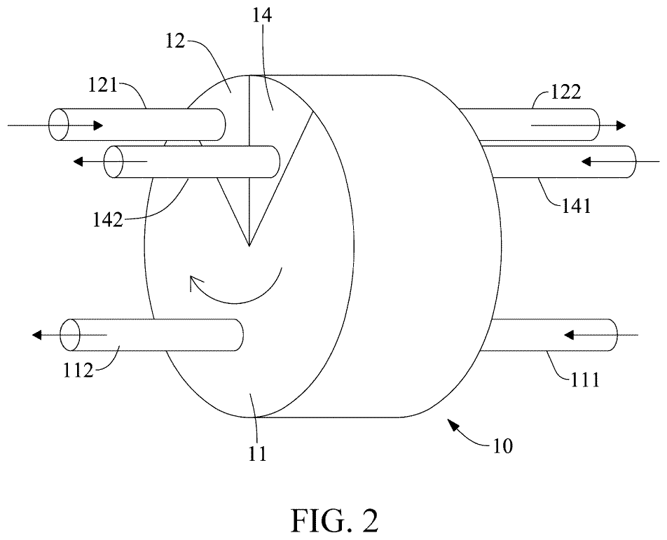

The wheel 10 is provided with an adsorption and desorption material (not shown in the figure) and can rotate. As shown in FIG. 2, the wheel 10 includes an adsorption zone 11 and a desorption zone 12. The adsorption zone 11 is connected with a waste gas inlet pipe 111 and a purified gas emission pipe 112. The desorption zone 12 is connected with a desorption gas inlet pipe 121 and a desorption gas outlet pipe 122. The desorption gas outlet pipe 122 is communicated with a concentrated gas outlet pipe 123. The desorption gas outlet pipe 122 and the waste gas inlet pipe 111 are connected by a concentrated gas bypass pipe 13, and a control valve 41 is arranged to control the concentrated gas bypass pipe 13 to be communicated or not communicated. In an embodiment, an adsorption and desorption sequence when the wheel 10 rotates is that the organic waste gas first passes through the adsorption zone 11 to allow organic substances to be adsorbed on the adsorption and desorption material, and then returns to the adsorption zone 11 after the organic substances being concentrated and desorbed by the desorption gas in the desorption zone 12, and this cycle continues.

As shown in FIG. 2, the wheel 10 further includes a cooling zone 14. The cooling zone 14 is provided with a cooling gas inlet pipe 141 and a cooling gas outlet pipe 142. Cooling gas passes through the adsorption and desorption material from the cooling gas inlet pipe 141 and then is discharged from the cooling gas outlet pipe 142 to cool the adsorption and desorption material that rotates to the cooling zone 14. The organic waste gas purification apparatus includes a heat exchange unit 60. The heat exchange unit 60 is connected between the cooling gas outlet pipe 142 and the desorption gas inlet pipe 121. The cooling gas flows into the heat exchange unit 60 for heating after being discharged from the cooling gas outlet pipe 142, and then enters the desorption gas inlet pipe 121 to form the desorption gas.

The organic waste gas supply unit 20 is connected to the waste gas inlet pipe 111 to provide organic waste gas to pass through the adsorption and desorption material from the adsorption zone 11 at a source air volume, and purified gas is discharged from the purified gas emission pipe 112.

The desorption gas supply unit 30 is connected to the desorption gas inlet pipe 121 to provide desorption gas to pass through the adsorption and desorption material from the desorption zone 12 at a desorption air volume, and concentrated gas produced by desorption is discharged from the desorption gas outlet pipe 122 and the concentrated gas outlet pipe 123. The organic waste gas purification apparatus includes an incineration unit 70. The incineration unit 70 is arranged in a combustion chamber 61 provided in the heat exchange unit 60. The organic waste gas enters the combustion chamber 61 from the concentrated gas outlet pipe 123, and the incineration unit 70 incinerates and purifies the organic substances into high-temperature gas, and the high-temperature gas provides a heat source for the heat exchange unit 60 to carry out heat exchange. In an embodiment, the incineration unit 70 is a recuperative thermal oxidizer (TO), but the present disclosure is not limited to this. The incineration unit 70 may also be of other types, for example, a regenerative thermal oxidizer (RTO), or a catalytic thermal oxidizer (CTO).

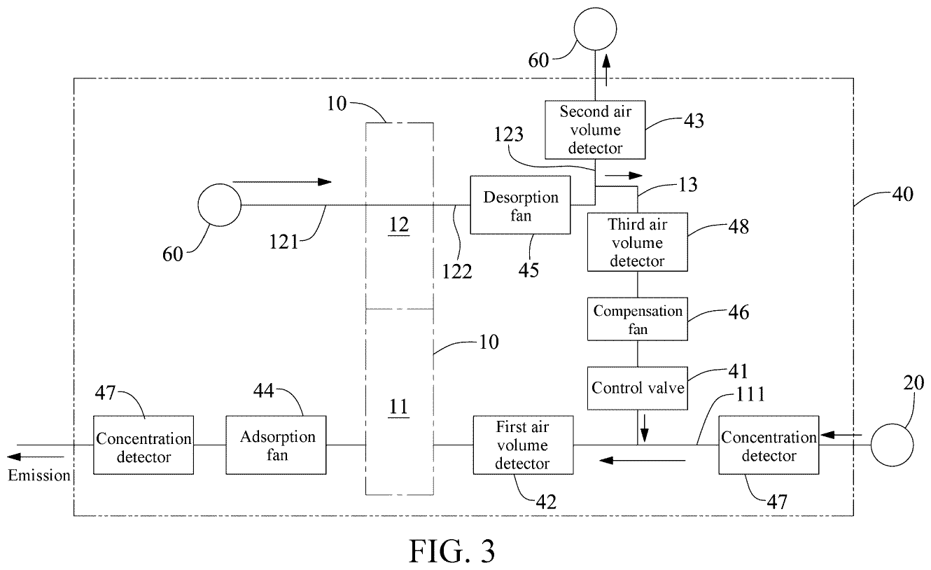

The control unit 40, as configured according to the first embodiment shown in FIG. 3, is electrically connected with the control valve 41, the organic waste gas supply unit 20 and the desorption gas supply unit 30. The control unit 40 receives the source air volume and the desorption air volume, and obtains an instant concentration ratio according to a ratio of the source air volume to the desorption air volume. When the source air volume and/or the concentration of organic waste gas are/is low, for example, when the instant concentration ratio is lower than a preset value, the control unit 40 can be adjusted to control the control valve 41 to make the concentrated gas bypass pipe 13 to be communicated to allow the concentrated gas flowing at the desorption air volume in the desorption gas outlet pipe 122 to be added to the waste gas inlet pipe 111 to compensate the source air volume at which the organic waste gas flows, so that the desorption air volume or the instant concentration ratio is controlled at a better wheel purification efficiency, for example, the desorption air volume or the instant concentration ratio is maintained at the preset value, and the concentration of organic waste gas in the concentrated gas outlet pipe 123 and the waste gas inlet pipe 111 is increased.

In an embodiment, the waste gas inlet pipe 111 is provided with a first air volume detector 42, and the first air volume detector 42 is configured to detect the source air volume. The concentrated gas outlet pipe 123 is provided with a second air volume detector 43, and the second air volume detector 43 is configured to detect the desorption air volume. The control unit 40 is electrically connected to the first air volume detector 42 and the second air volume detector 43 to receive the source air volume and the desorption air volume, respectively. In an embodiment, the first air volume detector 42 or the second air volume detector 43 is one of a flame ionization detector (FID), a pitot tube, and a flow-restriction plate.

In an embodiment, the purified gas emission pipe 112 is connected to an adsorption fan 44. The adsorption fan 44 is electrically connected with the control unit 40, and the control unit 40 controls the adsorption fan 44 to be turned on to produce the source air volume.

In an embodiment, the desorption gas outlet pipe 122 is connected to a desorption fan 45. The desorption fan 45 is electrically connected with the control unit 40, and the control unit 40 controls the desorption fan 45 to be turned on to produce the desorption air volume. A communication location of the concentrated gas bypass pipe 13 and the waste gas inlet pipe 111 is located behind the desorption fan 45. In an embodiment, the waste gas inlet pipe 111 and the purified gas emission pipe 112 are each provided with a concentration detector 47 to detect the concentration of the organic waste gas in the waste gas inlet pipe 111 and the purified gas emission pipe 112. In an embodiment, the concentrated gas bypass pipe 13 is provided with a third air volume detector 48 to detect an air volume of the concentrated gas when the concentrated gas passes through the concentrated gas bypass pipe 13.

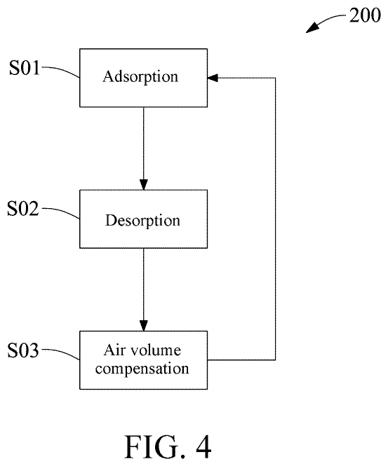

According to the aforementioned adsorption-desorption concentration device 100 capable of regulating desorption air volume or concentration ratio, the present disclosure further provides an adsorption-desorption concentration method 200, which, as shown in FIG. 4, mainly includes an adsorption step S01, a desorption step S02, and an air volume compensation step S03.

In the adsorption step S01, the organic waste gas supply unit 20 provides, through the waste gas inlet pipe 111, the organic waste gas to pass through the adsorption and desorption material from the adsorption zone 11 at the source air volume, and the source air volume is detected for the organic waste gas flowing in the waste gas inlet pipe 111.

In the desorption step S02, the desorption gas supply unit 30 provides, through the desorption gas inlet pipe 121, the desorption gas to pass through the adsorption and desorption material from the desorption zone 12 at a desorption air volume for desorption to produce the concentrated gas, and the desorption air volume is detected for the desorption gas flowing in the desorption gas inlet pipe 121.

The air volume compensation step S03 is executed during the execution of the above-mentioned adsorption step S01 and desorption step S02, where the control unit 40 obtains an instant concentration ratio according to a ratio of the source air volume to the desorption air volume, and whether the instant concentration ratio is lower than a preset value is further determined; if yes, the control unit 40 controls the control valve 41 to make the concentrated gas bypass pipe 13 to be communicated to allow the concentrated gas flowing at the desorption air volume in the desorption gas outlet pipe 122 to be added to the waste gas inlet pipe 111 to compensate the source air volume at which the organic waste gas flows, until the instant concentration ratio meets the preset value, and then the control unit 40 controls the control valve 41 to make the concentrated gas bypass pipe 13 to be not communicated. The steps are cycled to enable the instant concentration ratio to be maintained at the preset value.

For the above-mentioned adsorption-desorption concentration device 100 capable of regulating desorption air volume or concentration ratio and the concentration method 200 thereof, the specific operations are further explained as follows.

When the purification apparatus executes organic waste gas purification, assuming that the ratio at the preset value is 18, as shown in FIG. 1, if the source air volume is 150000 NCMH (M³/hr) as detected by the first air volume detector 42, based on that the ratio of the source air volume to the desorption air volume is 18, the control unit 40 can acquire that the desorption air volume should be 8333 NCMH (M³/hr), and the control unit 40 controls the desorption fan 45 to be turned on to produce the desorption air volume of 8333 NCMH (M³/hr). Under the condition that the source air volume and the desorption air volume remain unchanged, the control valve 41 can be kept closed, so that the concentrated gas bypass pipe 13 and the waste gas inlet pipe 111 are kept not communicated. At this time, the adsorption and desorption unit may be able to carry out the adsorption purification and desorption and concentration of the organic waste gas at the concentration ratio of 18, thereby achieving a preset organic waste gas purification efficiency.

Upon the above, assuming that during the waste gas purification process, for example, due to the load reduction of an apparatus for producing the organic waste gas, the source air volume decreases to 140000 NCMH (M³/hr). In this case, it can be known from calculation by the control unit 40 that the desorption air volume requires to be adjusted down to 77778 NCMH (M³/hr), so that the concentration ratio can be maintained at the preset value of 18. However, this may cause the problem of low flow rate of the desorption gas passing through the desorption zone 12, and when the desorption gas passes through the adsorption and desorption material in the desorption zone 12, the problem of insufficient desorption due to a significant drop in the outlet temperature is caused by insufficient wind power, thereby resulting in a decrease in the purification efficiency of the adsorption and desorption unit. During the actual operation of the adsorption-desorption concentration device 100 according to the first embodiment, assuming that the control unit 40 receives that the source air volume is less than 150000 NCMH (M³/hr), the control unit 40 can instantly make the control valve 41 open, that is, the concentrated gas bypass pipe 13 and the waste gas inlet pipe 111 are controlled to be communicated, so that the concentrated gas flowing in the concentrated gas bypass pipe 13 is added to the waste gas inlet pipe 111. When the source air volume is increased to 150000 NCMH (M³/hr), the control valve 41 is closed by the control unit 40, and this cycle continues. However, when the source air volume is low, the source air volume is compensated with the desorption air volume, so as to ensure that the concentration ratio is maintained at the preset value 18, and the desorption gas passing through the desorption zone 12 can maintain the wind power for passing through the adsorption and desorption material in the desorption zone 12, thereby avoiding the problem of insufficient desorption due to a significant drop in the outlet temperature.

Furthermore, the production rate of nitrogen oxide is mainly affected by the flame temperature and the concentration of various free radicals (refer to the content of “Reduced mechanisms for NOx emissions from hydrocarbon diffusion flames” published in the ScienceDirect Journal in 1996), which is applicable to the field of organic waste gas purification, that is, when the concentrated gas enters the incineration unit 70 for combustion purification, if the concentration is low, not only is more fuel consumed due to the prolonged combustion time, but also the concentration of thermal NOx produced by combustion may be high, thereby leading to the high concentration of nitrogen oxide emitted from a gas flue, and thus causing the problem of not complying with the environmental protection laws and regulations (ESG).

Returning to the example described in the first embodiment, assuming that the source air volume decreases (for example, decreases to 140000 NCMH (M³/hr)), not only is the concentration ratio of the organic waste gas affected, but also the concentration of the concentrated gas desorbed from the wheel 10 may be decreased, thereby causing the aforementioned problems of consumption of more fuel and higher concentration of nitrogen oxide. However, in the present disclosure, the control valve 41 is opened to make the concentrated gas bypass pipe 13 and the waste gas inlet pipe 111 to be communicated, so that the concentrated gas flowing in the concentrated gas bypass pipe 13 is added to the waste gas inlet pipe 111, thereby not only compensating the source air volume with the desorption air volume when the source air volume is low to ensure that the concentration ratio or the desorption air volume is maintained at the preset value, but also enabling the concentration of the source of organic waste gas that enters the incineration unit 70 to be improved, and thus solving the problems of consumption of fuel and high concentration of nitrogen oxide.

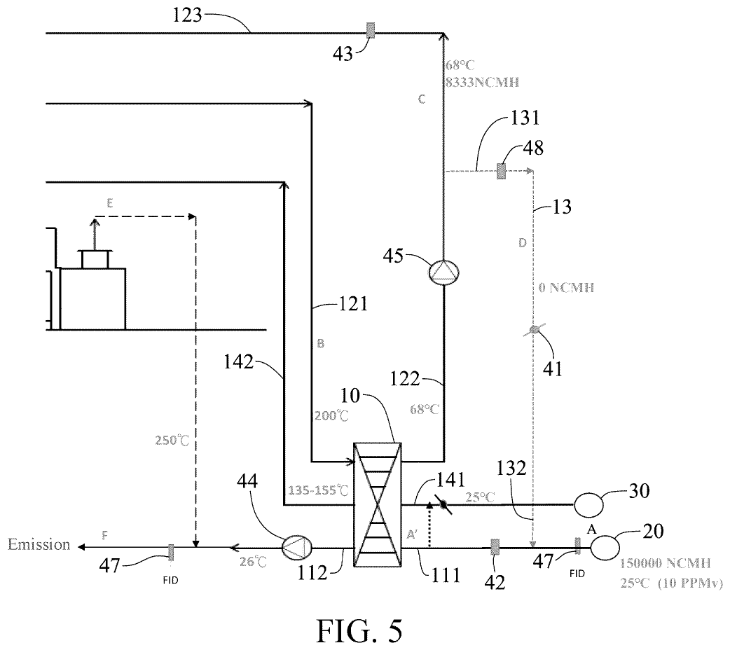

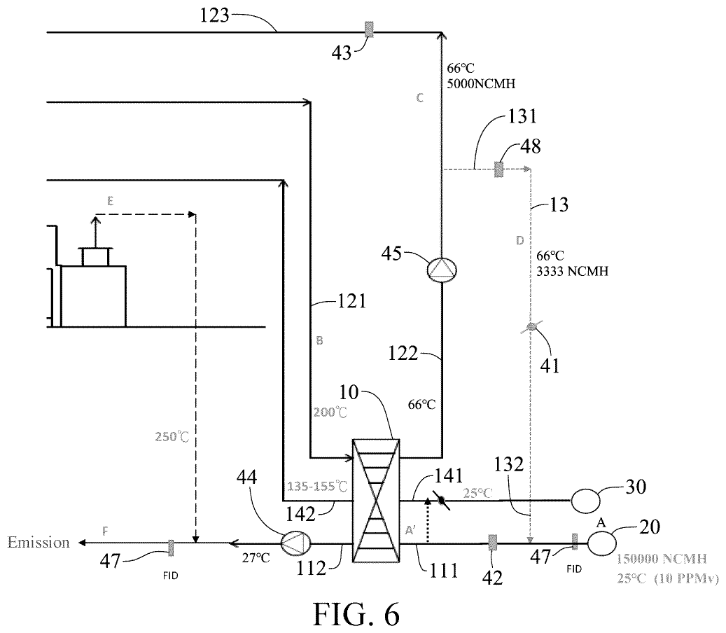

Referring to both Table 1-1 and Table 1-2 below, which are a data table executed in the first embodiment of the adsorption-desorption concentration device 100 and the concentration method 200 thereof of the present disclosure, where the first half of Table 1-1 is continued by the second half of Table 1-2. Table 1-1 and Table 1-2 each show three sets of experimental data for scenarios A, B and C. For the ratio of the concentration ratio, 18 is taken as the preset value, and the source air volume is 150000 NCMH (M³/hr). Therefore, the desorption air volume should be maintained at 8333 NCMH (M³/hr). Furthermore, in scenarios A and B, the control valve 41 is closed, that is, the concentrated gas flowing in the concentrated gas bypass pipe 13 does not flow into the waste gas inlet pipe 111, while in scenario C, the control valve 41 is open, that is, the concentrated gas flowing in the concentrated gas bypass pipe 13 flows into the waste gas inlet pipe 111 to compensate the air volume and the concentrated gas. The concentrations of VOCs from organic waste gas sources in scenarios A and B are 100 PPMv and 10 PPMv, respectively (see FIG. 1 and FIG. 5). By comparison, the nitrogen oxide emission in scenario A is 0.19 kg/hr (which can be converted into 1.65 tones/year), and the gas consumption in the purification process is 11.5 NM³/HR; while the nitrogen oxide emission in scenario B is increased to 0.55 kg/hr (which can be converted into 4.81 tones/year), and the gas consumption in the purification process is also increased to 46 NM³/HR. However, it can be seen from the experimental data for scenario C that the control valve 41 makes the concentrated gas flowing in the concentrated gas bypass pipe 13 (see FIG. 6) flow into the waste gas inlet pipe 111 at an air volume of 3333 NCMH (M³/hr) (40% of the desorption air volume) to compensate the air volume and the concentration of organic waste gas. Therefore, the following results are obtained: the source air volume of the organic waste gas is increased from 150000 NCMH (M³/hr) to 153333 NCMH (M³/hr), the concentration of the organic waste gas is increased from 173 PPMv to 287 PPMv, the nitrogen oxide emission is reduced to 0.27 kg/hr (which can be converted into 2.34 tones/year), and the gas consumption in the purification process is reduced to 25 NM³/HR.

Table 1-1 (the first half of the table; see the marked in FIG.
1 and FIG. 5 to FIG. 10 for “desorption face velocity”
shown in the table at A-F, the same applies to Table 2-1 and Table 3-1):

| (Scenario A)-Proportion of partial | | | | |
|---|---|---|---|---|
| reflux retreatment at outlet after | | | | |
| desorption from wheel | | 0% | | |
| | | Air | | Wheel |
| | | volume | Concentration | purification |
| | | NCMH | ratio of wheel | efficiency |
| | | (M³/hr) | times | % |
| Wheel diameter 4200 mm | Desorption | 2.0 | NM/S | |
| | face velocity | | | |
| Process waste gas source | A | 150000 | 18.0 | 97.0% |
| Wheel waste gas inlet | A′ | 150000 | | |
| Wheel desorption inlet | B | 8333 | | |
| Stream at outlet after | C | 8333 | | |
| desorption from wheel is | | | | |
| diverted to thermal | | | | |
| oxidizer (TO) | | | | |
| Partial reflux retreatment | D | 0 | | |
| at outlet after desorption | | | | |
| from wheel | | | | |
| TO outlet | E | 8333 | | |
| Chimney emission | F | 158333 | | |
| (Scenario B)-Proportion of partial | | | | |
| reflux retreatment at outlet after | | | | |
| desorption from wheel | | 0% | | |
| Wheel diameter 4200 mm | Desorption | 2.0 | NM/S | |
| | face velocity | | | |
| Process waste gas source | A | 150000 | 18.0 | 96.0% |
| Wheel waste gas inlet | A′ | 150000 | | |
| Wheel desorption inlet | B | 8333 | | |
| Stream at outlet after | C | 8333 | | |
| desorption from wheel is | | | | |
| diverted to thermal | | | | |
| oxidizer (TO) | | | | |
| Partial reflux retreatment | D | 0 | | |
| at outlet after desorption | | | | |
| from wheel | | | | |
| TO outlet | E | 8333 | | |
| Chimney emission | F | 158333 | | |
| (Scenario C)-Proportion of partial | | | | |
| reflux retreatment at outlet after | | | | |
| desorption from wheel | | 40% | | |
| Wheel diameter 4200 mm | Desorption | 2.0 | NM/S | |
| | face velocity | | | |
| Process waste gas source | A | 150000 | 18.4 | 95.8% |
| Wheel waste gas inlet | A′ | 153333 | | |
| Wheel desorption inlet | B | 8333 | | |
| Stream at outlet after | C | 5000 | | |
| desorption from wheel is | | | | |
| diverted to thermal | | | | |
| oxidizer (TO) | | | | |
| Partial reflux retreatment | D | 3333 | | |
| at outlet after desorption | | | | |
| from wheel | | | | |
| TO outlet | E | 5000 | | |
| Chimney emission | F | 155000 | | |

Table 1-2 (first half): NOx molecular weight

| Wheel | | | | | |
|---|---|---|---|---|---|
| purification | Concentration | Gas | Concentration | | |
| efficiency | of VOCs | consumption | of NOx | NOx emission | |
| % | PPMv | NM³/hr | PPMv | Kgs/hr | Tons/year |
| 97.0% | 100 | 11.5 | 0 | | |
| | | | 0 | | |
| | 1746 | | | | |
| | 0 | | | | |
| | 1.75 | | 11 | 0.19 | 1.65 |
| | 3 | | 0.58 | | |
| | | | NOx molecular | 46 | |
| | | | weight | | |
| 96.0% | 10 | 46 | 0 | | |
| | | | 0 | | |
| | 173 | | | | |
| | 0 | | | | |
| | 0.17 | | 32 | 0.55 | 4.81 |
| | 0.4 | | 1.68 | | |
| | | | NOx molecular | 46 | |
| | | | weight | | |
| 95.8% | 10 | 25 | 0 | | |
| | | | 0 | | |
| | 287 | | | | |
| | 287 | | | | |
| | 0.29 | | 26 | 0.27 | 2.34 |
| | 0.42 | | 0.84 | | |

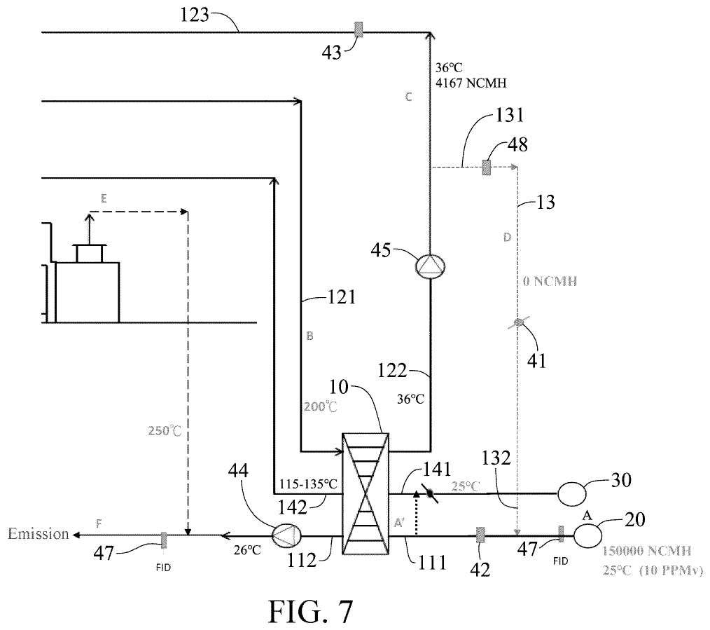

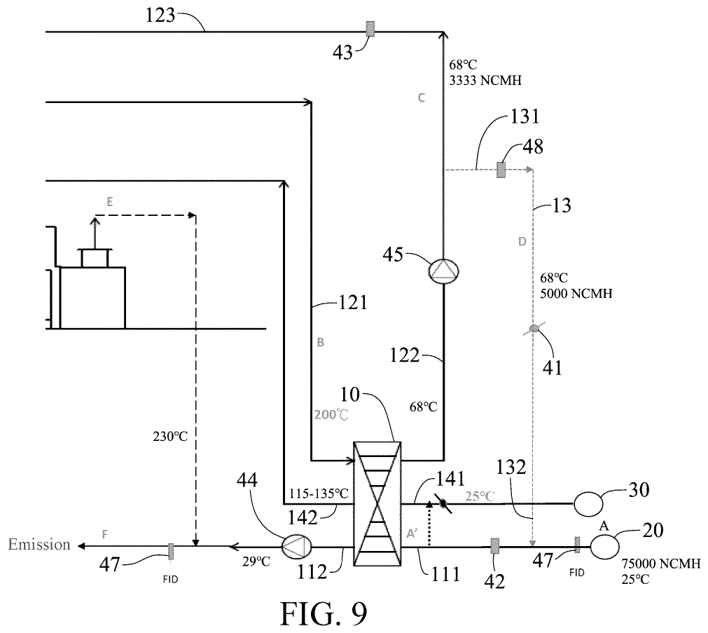

Further, referring to both Table 2-1 and Table 2-2 below, which are another data table executed in the first embodiment of the adsorption-desorption concentration device 100 and the concentration method 200 thereof of the present disclosure, where the first half of Table 2-1 is continued by the second half of Table 2-2. Table 2-1 and Table 2-2 each show three sets of experimental data for scenarios D, E and F. For the ratio of the concentration ratio, 18 is taken as the preset value in scenario D, while 9 is taken as the preset value in scenarios E and F. As shown in FIG. 7 to FIG. 9, the source air volume of scenario D is 150000 NCMH (M³/hr), while the source air volume of each of scenarios E and F is 75000 NCMH (M³/hr). Therefore, the desorption air volume in scenario D should be maintained at 4167 NCMH (M³/hr), while the desorption air volume in scenarios E and F should be maintained at 8333 NCMH (M³/hr). Furthermore, in scenarios D and E, the control valve 41 is closed, while in scenario F, the control valve 41 is open, that is, the concentrated gas flowing in the concentrated gas bypass pipe 13 flows into the waste gas inlet pipe 111 to compensate the air volume and the concentrated gas. The concentrations of VOCs from organic waste gas sources in scenarios D and E are 100 PPMv and 30 PPMv, respectively. By comparison, the nitrogen oxide emission in scenario D is 0.11 kg/hr (which can be converted into 0.98 tones/year), and the gas consumption in the purification process is 5.7 NM³/HR; while the nitrogen oxide emission in scenario E is increased to 0.6 kg/hr (which can be converted into 5.26 tones/year), and the gas consumption in the purification process is also increased to 46.8 NM³/HR, and it is also obtained by detection that the carbon dioxide production is 922 tones/year. However, it can be seen from the experimental data for scenario F that the control valve 41 makes the concentrated gas flowing in the concentrated gas bypass pipe 13 (see FIG. 9) flow into the waste gas inlet pipe 111 at an air volume of 5000 NCMH (M³/hr) (60% of the desorption air volume) to compensate the air volume and the concentration of organic waste gas. Therefore, the following results are obtained: the source air volume of the organic waste gas is increased from 75000 NCMH (M³/hr) to 80000 NCMH (M³/hr), the concentration of the concentrated gas is increased from 261 PPMv to 651 PPMv, the nitrogen oxide emission is reduced to 0.10 kg/hr (which can be converted into 0.90 tones/year), and the gas consumption in the purification process is reduced to 15.1 NM³/HR, and it is also obtained by detection that the carbon dioxide production is 376 tones/year, achieving a reduction of 59%.

Table 2-1 (first half):

| (Scenario D)-Proportion of | | | | | |
|---|---|---|---|---|---|
| partial reflux retreatment | | | | | |
| at outlet after desorption | | | | | |
| from wheel | | 0% | | | |
| | | Air | | Wheel | |
| | | volume | Concentration | purification | Concentration |
| | | NCMH | ratio of wheel | efficiency | of VOCs |
| | | (M³/hr) | times | % | PPMv |
| Wheel diameter | Desorption | 1.0 | NM/S | | |
| 4200 mm | face | | | | |
| | velocity | | | | |
| Process waste | A | 75000 | 18.0 | 89.0% | 100 |
| gas source | | | | | |
| Wheel waste | A′ | 75000 | | | |
| gas inlet | | | | | |
| Wheel | B | 4167 | | | |
| desorption inlet | | | | | |
| Stream at outlet | C | 4167 | | | 1602 |
| after desorption | | | | | |
| from wheel is | | | | | |
| diverted to | | | | | |
| thermal | | | | | |
| oxidizer (TO) | | | | | |
| Partial reflux | D | 0 | | | |
| retreatment at | | | | | |
| outlet after | | | | | |
| desorption | | | | | |
| from wheel | | | | | |
| TO outlet | E | 4167 | | | 1.60 |
| Chimney | F | 79167 | | | 11 |
| emission | | | | | |
| (Scenario E)-Proportion of | | | | | |
| partial reflux retreatment | | | | | |
| at outlet after desorption | | | | | |
| from wheel | | 0% | | | |
| Wheel diameter | Desorption | 2.0 | NM/S | | |
| 4200 mm | face | | | | |
| | velocity | | | | |
| Process waste | A | 75000 | 9.0 | 96.8% | 30 |
| gas source | | | | | |
| Wheel waste | A′ | 75000 | | | |
| gas inlet | | | | | |
| Wheel | B | 8333 | | | |
| desorption inlet | | | | | |
| Stream at outlet | C | 8333 | | | 261 |
| after desorption | | | | | |
| from wheel is | | | | | |
| diverted to | | | | | |
| thermal | | | | | |
| oxidizer (TO) | | | | | |
| Partial reflux | D | 0 | | | |
| retreatment at | | | | | |
| outlet after | | | | | |
| desorption | | | | | |
| from wheel | | | | | |
| TO outlet | E | 8333 | | | 0.26 |
| Chimney | F | 83333 | | | 0.96 |
| emission | | | | | |
| (Scenario F)-Proportion of | | | | | |
| partial reflux retreatment | | | | | |
| at outlet after desorption | | | | | |
| from wheel | | 60% | | | |
| Wheel diameter | Desorption | 2.0 | NM/S | | |
| 4200 mm | face | | | | |
| | velocity | | | | |
| Process waste | A | 75000 | 9.6 | 96.5% | 30 |
| gas source | | | | | |
| Wheel waste | A | 80000 | | | |
| gas inlet | | | | | |
| Wheel | B | 8333 | | | |
| desorption inlet | | | | | |
| Stream at outlet | C | 3333 | | | 651 |
| after desorption | | | | | |
| from wheel is | | | | | |
| diverted to | | | | | |
| thermal | | | | | |
| oxidizer (TO) | | | | | |
| Partial reflux | D | 5000 | | | 651 |
| retreatment at | | | | | |
| outlet after | | | | | |
| desorption | | | | | |
| from wheel | | | | | |
| TO outlet | E | 3333 | | | 0.65 |
| Chimney | F | 78333 | | | 1.05 |
| emission | | | | | |

TABLE 2-2
(second half):

| | | NOx molecular | | | | |
|---|---|---|---|---|---|---|
| | | weight | | | | |
| Concen- | Gas | Concen- | 46 | | | |
| tration | con- | tration | NOx emission | | | |
| of VOCs | sumption | of NOx | | Tons/ | | |
| PPMv | NM³/hr | PPMv | Kgs/hr | year | | |
| 100 | 5.7 | 0 | | | | |
| | | 0 | | | | |
| | | | | | 2657 | scfm |
| 1602 | | | | | 2657 | scfm |
| 1.60 | | 13 | 0.11 | 0.98 | | |
| 11 | | 0.68 | | | | |
| 30 | 46.8 | 0 | | | | |
| | | 0 | | | | |
| | | | | | 5313 | scfm |
| 261 | | | | | 5313 | scfm |
| 0.26 | | 35 | 0.60 | 5.26 | | |
| 0.96 | | 3.50 | | | | |
| 30 | 15.1 | 0 | | | | |
| | | 0 | | | | |
| | | | | | 5313 | scfm |
| 651 | | | | | 2125 | scfm |
| 651 | | | | | | |
| 0.65 | | 15 | 0.10 | 0.90 | | |
| 1.05 | | 0.64 | | | | |

Therefore, according to the adsorption-desorption concentration device 100 capable of regulating desorption air volume or concentration ratio and the concentration method thereof 200 provided by the present disclosure, the concentrated gas in the desorption gas outlet pipe 122 is added to the waste gas inlet pipe 111 to compensate the air volume of the organic waste gas, so that the instant concentration ratio or the desorption air volume can be controlled at a preset value, thereby maintaining a purification efficiency, and the concentration of organic waste gas in the waste gas inlet pipe 111 can be increased to help reduce the combustion air volume and shorten the combustion time and thus save fuel and reduce nitrogen oxide emissions, thereby complying with environmental protection laws and regulations.

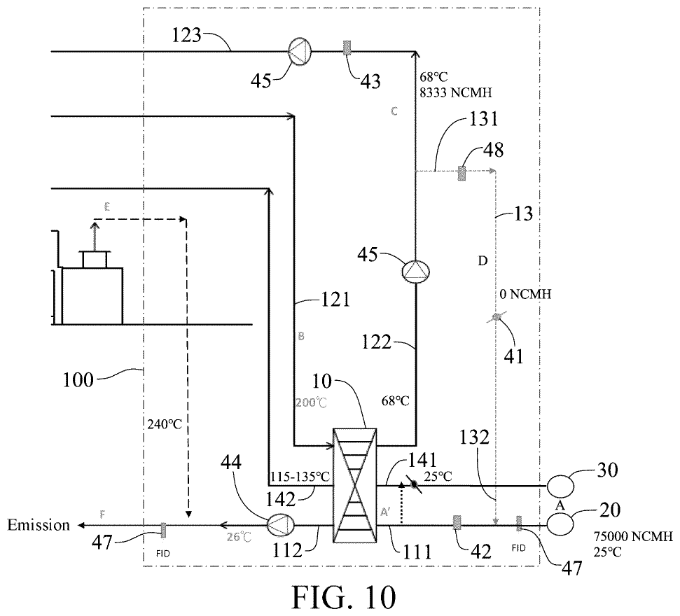

FIG. 10 shows a second embodiment of the present disclosure, which is mainly different from the first embodiment in that the desorption gas outlet pipe 122 and the concentrated gas outlet pipe 123 in this embodiment are connected to two desorption fans 45, and the two desorption fans 45 are both electrically connected with the control unit 40. In this embodiment, the control unit 40 controls the two desorption fans 45 to be turned on to generate the desorption air volume, thereby not only achieving the same effect as that in the first embodiment, but also realizing the regulation of the desorption air volume in practical applications. In addition, the desorption fan 45 (not shown in the figure) can also be arranged only in the concentrated gas outlet pipe 123 to meet the needs of practical applications.

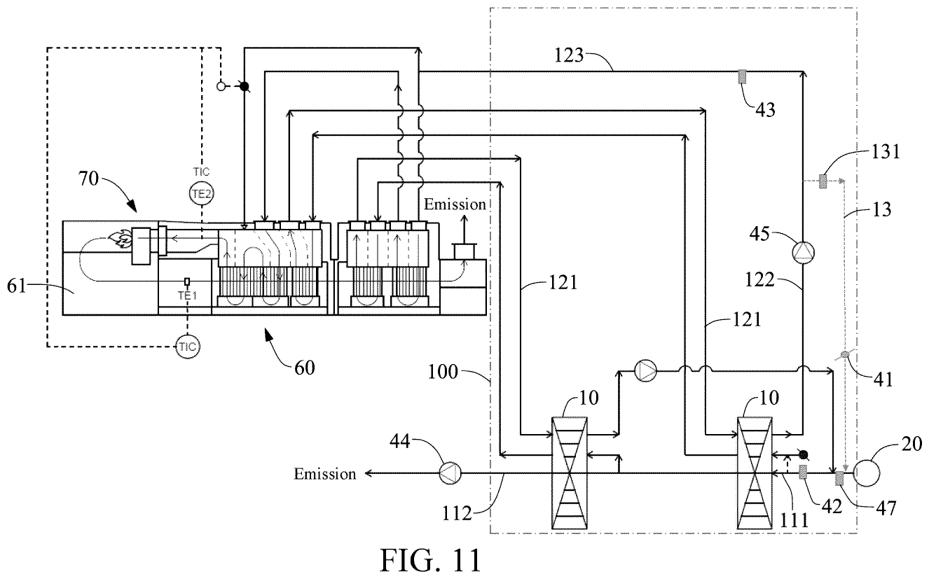

FIG. 11 shows a third embodiment of the present disclosure, which is mainly different from the first embodiment in that there are two wheels 10 of the adsorption and desorption unit in this embodiment. One of the two wheels 10 has the concentrated gas bypass pipe 13 communicated between the concentrated gas outlet pipe 123 and the waste gas inlet pipe 111 as in the first embodiment, and a communication location is located behind the desorption fan 45. The control valve 41 is arranged as well, thereby not only achieving the same effect as in the first embodiment, but also improving the adsorption and desorption purification efficiency of the organic waste gas.

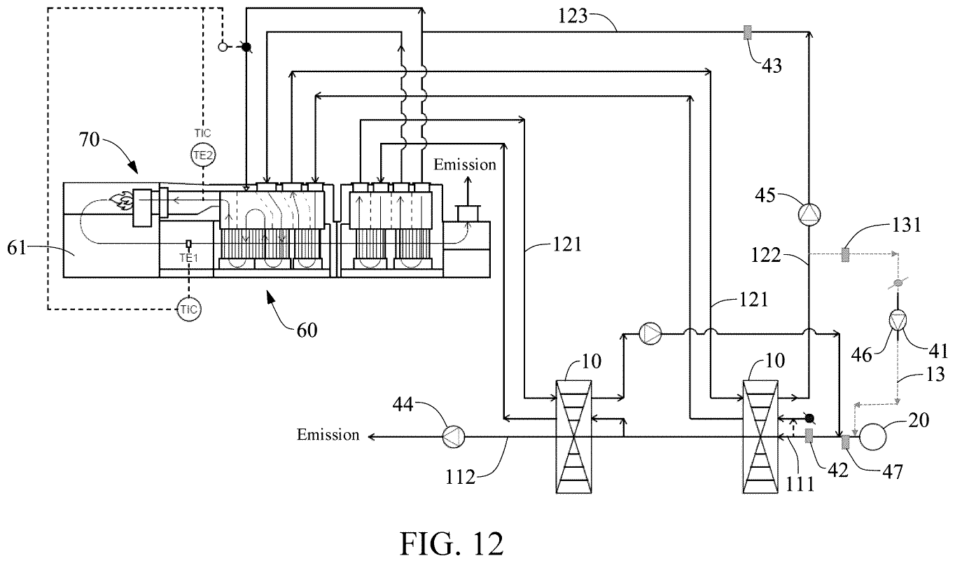

Further, FIG. 12 shows a fourth embodiment of the present disclosure, which is mainly different from the third embodiment in that a communication location of the concentrated gas bypass pipe 13 between the concentrated gas outlet pipe 123 and the waste gas inlet pipe 111 is located in front of the desorption fan 45, and the concentrated gas bypass pipe 13 is connected to a compensation fan 46. The compensation fan 46 is electrically connected with the control unit 40. An inlet end 131 of the concentrated gas bypass pipe 13 is communicated with the desorption gas outlet pipe 122 and located in front of the desorption fan 45, and an outlet end 132 of the concentrated gas bypass pipe 13 is communicated with the waste gas inlet pipe 111. While making the control valve 41 open, the control unit 40 also makes the compensation fan 46 to be turned on, and the concentrated gas from the desorption gas outlet pipe 122 is drawn into the concentrated gas bypass pipe 13 from the inlet end 131 by the compensation fan 46, and is introduced into the waste gas inlet pipe 111 from the outlet end 132.

Further, referring to both Table 3-1 and Table 3-2, which are a data table executed in the fourth embodiment of the adsorption-desorption concentration device 100 and the concentration method 200 thereof of the present disclosure, where the first half of Table 3-1 is continued by the second half of Table 3-2. Table 3-1 and Table 3-2 each show three sets of experimental data for scenarios G, H and I. For the ratio of the concentration ratio, 18 is taken as the preset value in scenario G (not shown in the figure), while 9 is taken as the preset value in scenarios H and I (not shown in the figure), where the source air volume in each of scenarios G, H and I is 75000 NCMH (M³/hr). Therefore, the desorption air volume in scenario G should be maintained at 4167 NCMH (M³/hr), while the desorption air volume in scenarios H and I should be maintained at 8333 NCMH (M³/hr). Furthermore, in scenarios G and H, the control valve 41 is closed, while in scenario I, the control valve 41 is open, that is, the concentrated gas flowing in the concentrated gas bypass pipe 13 flows into the waste gas inlet pipe 111 to compensate the air volume and the concentrated gas. In scenario H, only the desorption fan 45 is actuated, and the power consumption thereof is 34.9 KW as measured. However, in scenario I, due to the cooperative operation of the compensation fan 46, the nitrogen oxide emission is 0.10 kg/hr (which can be converted into 0.9 tones/year) as experimentally measured, which is significantly reduced as compared with the nitrogen oxide emission of 0.60 kg/hr (which can be converted into 5.26 tones/year) in scenario H, and the power consumption of the desorption fan 45 is 14 KW as measured, and the power consumption of the compensation fan 46 is 3.63 KW as measured, which is 17.63 KW in total. Compared with the power consumption of 34.9 KW of the desorption fan 45 in scenario H, the power consumption is reduced by 47%. Therefore, this embodiment can not only achieve the same effect as the third embodiment, but also has the effect of reducing the power consumption of the fan.

TABLE 3-1
(first half):

| (Scenario G)- | | | | | | |
|---|---|---|---|---|---|---|
| Proportion of partial | | | | | | |
| reflux retreatment at | | 0% | | | | |
| outlet after desorption | | 1.0 | | | | |
| from wheel | | Air | NM/S | Wheel | | |
| Wheel | Desorption | volume | Concentration | purification | Concentration | Gas |
| diameter | face | NCMH | ratio of wheel | efficiency | of VOCs | consumption |
| 4200 mm | velocity | (M³/hr) | times | % | PPMv | NM³/hr |
| Process | A | 75000 | 18.0 | 89.0% | 100 | 5.7 |
| waste gas | | | | | | |
| source | | | | | | |
| Wheel | A′ | 75000 | | | | |
| waste gas | | | | | | |
| inlet | | | | | | |
| Wheel | B | 4167 | | | | |
| desorption | | | | | | |
| inlet | | | | | | |
| Stream at | C | 4167 | | | 1602 | |
| outlet after | | | | | | |
| desorption | | | | | | |
| from wheel | | | | | | |
| is diverted | | | | | | |
| to thermal | | | | | | |
| oxidizer | | | | | | |
| (TO) | | | | | | |
| Partial | D | 0 | | | | |
| reflux | | | | | | |
| retreatment | | | | | | |
| at outlet | | | | | | |
| after | | | | | | |
| desorption | | | | | | |
| from wheel | | | | | | |
| TO outlet | E | 4167 | | | 1.60 | |
| Chimney | F | 79167 | | | 11 | |
| emission | | | | | | |
| (Scenario H)- | | | | | | |
| Proportion of partial | | | | | | |
| reflux retreatment at | | 0% | | | | |
| outlet after desorption | | 2.0 | | | | |
| from wheel | | Air | NM/S | Wheel | | |
| Wheel | Desorption | volume | Concentration | purification | Concentration | Gas |
| diameter | face | NCMH | ratio of wheel | efficiency | of VOCs | consumption |
| 4200 mm | velocity | (M³/hr) | times | % | PPMv | NM³/hr |
| Process | A | 75000 | 9.0 | 96.8% | 30 | 46.8 |
| waste gas | | | | | | |
| source | | | | | | |
| Wheel | A′ | 75000 | | | | |
| waste gas | | | | | | |
| inlet | | | | | | |
| Wheel | B | 8333 | | | | |
| desorption | | | | | | |
| inlet | | | | | | |
| Stream at | C | 8333 | | | 261 | |
| outlet after | | | | | | |
| desorption | | | | | | |
| from wheel | | | | | | |
| is diverted | | | | | | |
| to thermal | | | | | | |
| oxidizer | | | | | | |
| (TO) | | | | | | |
| Partial | D | 0 | | | | |
| reflux | | | | | | |
| retreatment | | | | | | |
| at outlet | | | | | | |
| after | | | | | | |
| desorption | | | | | | |
| from wheel | | | | | | |
| TO outlet | E | 8333 | | | 0.26 | |
| Chimney | F | 83333 | | | 0.96 | |
| emission | | | | | | |
| (Scenario I)- | | | | | | |
| Proportion of partial | | | | | | |
| reflux retreatment at | | 60% | | | | |
| outlet after desorption | | 2.0 | | | | |
| from wheel | | Air | NM/S | Wheel | | |
| Wheel | Desorption | volume | Concentration | purification | Concentration | Gas |
| diameter | face | NCMH | ratio of wheel | efficiency | of VOCs | consumption |
| 4200 mm | velocity | (M³/hr) | times | % | PPMv | NM³/hr |
| Process | A | 75000 | 9.6 | 96.5% | 30 | 15.1 |
| waste gas | | | | | | |
| source | | | | | | |
| Wheel | A′ | 80000 | | | | |
| waste gas | | | | | | |
| inlet | | | | | | |
| Wheel | B | 8333 | | | | |
| desorption | | | | | | |
| inlet | | | | | | |
| Stream at | | | | | | |
| outlet after | | | | | | |
| desorption | | | | | | |
| from wheel | C | 3333 | | | 651 | |
| is diverted | | | | | | |
| to thermal | | | | | | |
| oxidizer | | | | | | |
| (TO) | | | | | | |
| Partial | D | 5000 | | | 651 | |
| reflux | | | | | | |
| retreatment | | | | | | |
| at outlet | | | | | | |
| after | | | | | | |
| desorption | | | | | | |
| from wheel | | | | | | |
| TO outlet | E | 3333 | | | 0.65 | |
| Chimney | F | 78333 | | | 1.05 | |
| emission | | | | | | |

TABLE 3-2
(second half):

| | NOx molecular | | | Power | Power | | |
|---|---|---|---|---|---|---|---|
| | weight | | | consumption | consumption | | |
| Gas | Concentration | 46 | | of desorption | of reflux | | |
| consumption | of NOx | NOx emission | | windmill (121) | windmill (123) | | |
| NM³/hr | PPMv | Kgs/hr | Tons/year | KW | KW | | |
| 5.7 | 0 | | | 17.5 | 0 | | |
| | 0 | | | | | | |
| | | | | | | 2657 | scfm |
| | | | | | | 2657 | scfm |
| | 13 | 0.11 | 0.98 | | | | |
| | 0.68 | | | | | | |
| 46.8 | 0 | | | 34.9 | 0 | | |
| | 0 | | | | | | |
| | | | | | | 5313 | scfm |
| | | | | | | 5313 | scfm |
| | 35 | 0.60 | 5.26 | | | | |
| | 3.50 | | | | | | |
| 15.1 | 0 | | | 14.0 | 3.63 | | |
| | 0 | | | | | | |
| | | | | | | 5313 | scfm |
| | | | | | | 2125 | scfm |
| | 15 | 0.10 | 0.90 | | | | |
| | 0.64 | | | | | | |

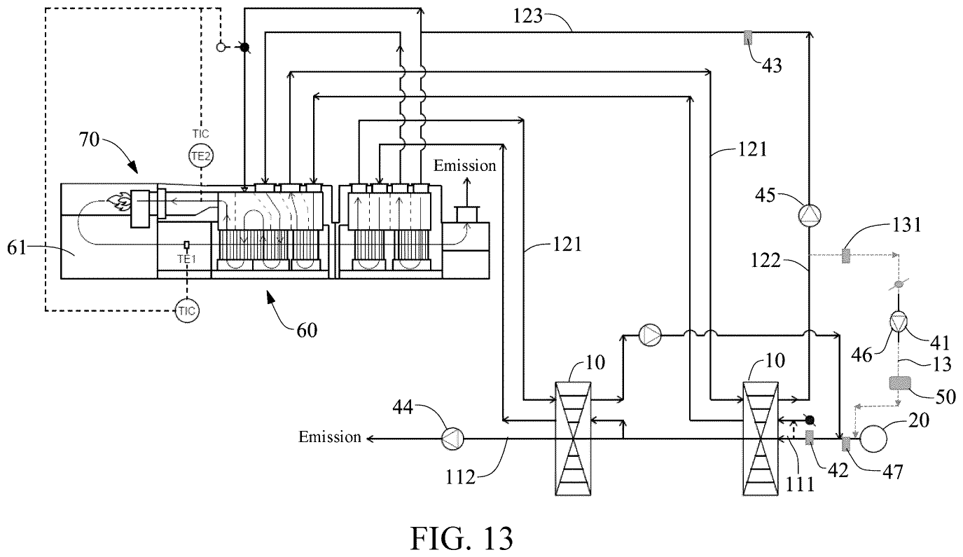

FIG. 13 shows a fifth embodiment of the present disclosure, which is mainly different from the fourth embodiment in that the adsorption and desorption unit in this embodiment is further connected to a non-destructive organic waste gas treater 50 between the compensation fan 46 and the outlet end 132 of the concentrated gas bypass pipe 13, thereby not only achieving the same effect as the fourth embodiment, but also improving the adsorption and desorption purification efficiency of the organic waste gas.

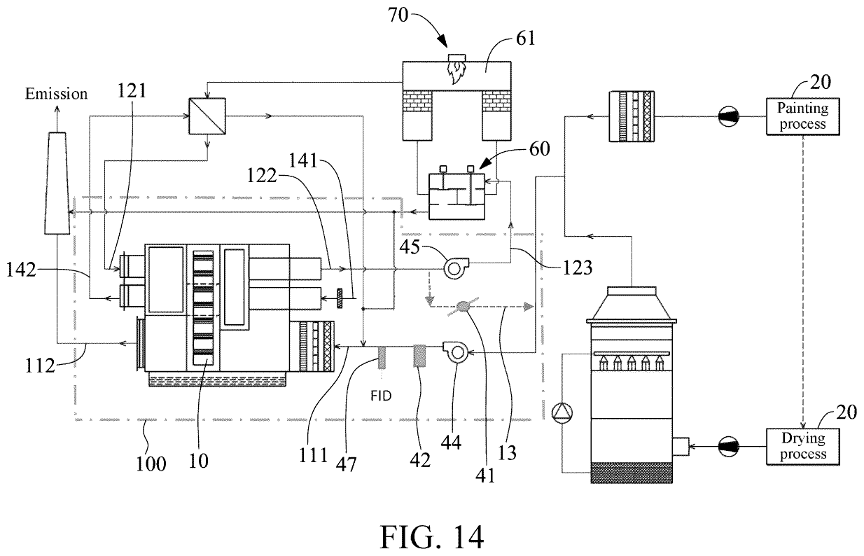

FIG. 14 shows a sixth embodiment of the present disclosure, which is mainly different from the aforementioned embodiments in that the adsorption-desorption concentration device 100 in this embodiment is applied to the treatment of organic waste gas in painting operations, and the incineration unit 70 of the organic waste gas purification apparatus applied is a regenerative thermal oxidizer.

While the present disclosure has been described by means of specific embodiments, numerous modifications and variations could be made thereto by those skilled in the art without departing from the scope and spirit of the present disclosure set forth in the claims.

What is claimed is:

1. An adsorption-desorption concentration device capable of regulating desorption air volume or concentration ratio, the adsorption-desorption concentration device being used for gas concentration of an organic waste gas purification apparatus, and comprising:
an adsorption and desorption unit, provided with an adsorption and desorption material and comprising an adsorption zone and a desorption zone, wherein the adsorption zone is connected with a waste gas inlet pipe and a purified gas emission pipe, and the desorption zone is connected with a desorption gas inlet pipe and a desorption gas outlet pipe, the desorption gas outlet pipe is communicated with a concentrated gas outlet pipe, the desorption gas outlet pipe and the waste gas inlet pipe are connected by a concentrated gas bypass pipe, and a control valve is arranged to control the concentrated gas bypass pipe to be communicated or not communicated; wherein an organic waste gas is provided via the waste gas inlet pipe to pass through the adsorption and desorption material from the adsorption zone at a source air volume, and a desorption gas is provided via the desorption gas inlet pipe to pass through the adsorption and desorption material from the desorption zone at a desorption air volume; and
a control unit, electrically connected with the control valve, wherein the control unit receives the source air volume and the desorption air volume, and when the source air volume and/or the concentration of organic waste gas introduced by the waste gas inlet pipe are/is low, the control unit is adjusted to control the control valve to make the concentrated gas bypass pipe to be communicated to allow the concentrated gas flowing at the desorption air volume in the desorption gas outlet pipe to be added to the waste gas inlet pipe to compensate the source air volume at which the organic waste gas flows, so that the desorption air volume or the concentration ratio is controlled at a better wheel purification efficiency.

2. The adsorption-desorption concentration device according to claim 1, further comprising an organic waste gas supply unit and a desorption gas supply unit, the organic waste gas supply unit and the desorption gas supply unit being electrically connected to the control unit, wherein the organic waste gas supply unit is connected to the waste gas inlet pipe to provide the organic waste gas to pass through the adsorption and desorption material from the adsorption zone at the source air volume for purification and then purified gas is discharged from the purified gas emission pipe; and the desorption gas supply unit is connected to the desorption gas inlet pipe to provide desorption gas to pass through the adsorption and desorption material from the desorption zone at the desorption air volume for desorption and then concentrated gas produced is discharged from the desorption gas outlet pipe and the concentrated gas outlet pipe.

3. The adsorption-desorption concentration device according to claim 2, wherein the waste gas inlet pipe is provided with a first air volume detector, the first air volume detector is configured to detect the source air volume; the concentrated gas outlet pipe is provided with a second air volume detector, the second air volume detector is configured to detect the desorption air volume; and the control unit is electrically connected to the first air volume detector and the second air volume detector to receive the source air volume and the desorption air volume, respectively.

4. The adsorption-desorption concentration device according to claim 3, wherein the purified gas emission pipe is connected to an adsorption fan, the adsorption fan is electrically connected with the control unit, and the control unit controls the adsorption fan to be turned on to produce the source air volume.

5. The adsorption-desorption concentration device according to claim 3, wherein the desorption gas outlet pipe and/or the concentrated gas outlet pipe are/is connected to a desorption fan, the desorption fan is electrically connected with the control unit, and the control unit controls the desorption fan to be turned on to produce the desorption air volume, wherein a communication location of the concentrated gas bypass pipe and the waste gas inlet pipe is located behind the desorption fan.

6. The adsorption-desorption concentration device according to claim 5, wherein the concentrated gas bypass pipe is connected to a compensation fan, the compensation fan is electrically connected with the control unit, an inlet end of the concentrated gas bypass pipe is communicated with the desorption gas outlet pipe and located in front of the desorption fan, and an outlet end of the concentrated gas bypass pipe is communicated with the waste gas inlet pipe, while making the control valve open, the control unit also makes the compensation fan to be turned on, and the concentrated gas from the desorption gas outlet pipe is drawn into the concentrated gas bypass pipe from the inlet end by the compensation fan, and is introduced into the waste gas inlet pipe from the outlet end.

7. The adsorption-desorption concentration device according to claim 6, wherein the concentrated gas bypass pipe is connected to a non-destructive organic waste gas treater between the compensation fan and the outlet end.

8. The adsorption-desorption concentration device according to claim 3, wherein the first air volume detector or the second air volume detector is one of a flame ionization detector, a pitot tube, and a flow-restriction plate.

9. The adsorption-desorption concentration device according to claim 1, wherein the adsorption and desorption unit is a wheel capable of rotating the adsorption and desorption material, and an adsorption and desorption sequence when the adsorption and desorption material rotates is that the organic waste gas first passes through the adsorption zone to allow organic substances to be adsorbed on the adsorption and desorption material, and then returns to the adsorption zone after the organic substances being concentrated and desorbed by the desorption gas in the desorption zone, and this cycle continues.

10. The adsorption-desorption concentration device according to claim 9, wherein the adsorption and desorption unit further comprises a cooling zone, the cooling zone is provided with a cooling gas inlet pipe and a cooling gas outlet pipe, and cooling gas passes through the adsorption and desorption material from the cooling gas inlet pipe and then is discharged from the cooling gas outlet pipe to cool the adsorption and desorption material that rotates to the cooling zone.

11. An adsorption-desorption concentration method of the device according to claim 1, comprising the following steps:
adsorption: providing, through the waste gas inlet pipe, the organic waste gas to pass through the adsorption and desorption material from the adsorption zone at the source air volume, and detecting the source air volume for the organic waste gas flowing in the waste gas inlet pipe;
desorption: providing, through the desorption gas inlet pipe, the desorption gas to pass through the adsorption and desorption material from the desorption zone at the desorption air volume for desorption to produce the concentrated gas, and detecting the desorption air volume for the desorption gas flowing in the desorption gas inlet pipe; and
air volume compensation: during the execution of the steps of the adsorption and the desorption, obtaining, by the control unit, an instant concentration ratio according to a ratio of the source air volume to the desorption air volume, and further determining whether the desorption air volume or the instant concentration ratio is lower than a preset value, if yes, controlling, by the control unit, the control valve to make the concentrated gas bypass pipe to be communicated to allow the concentrated gas flowing at the desorption air volume in the desorption gas outlet pipe to be added to the waste gas inlet pipe to compensate the source air volume at which the organic waste gas flows, until the desorption air volume or the instant concentration ratio meets the preset value, and then controlling, by the control unit, the control valve to make the concentrated gas bypass pipe to be not communicated, wherein the steps are cycled to enable the desorption air volume or the instant concentration ratio to be maintained at the preset value.
